(19) United States
(12) Patent Application Publication
(10) Pub. No.: US 2018/0192597 A1
(43) Pub. Date: Jul. 12, 2018

(54) System For Growing Plants In A Mobile And Controlled Environment And Method For Making The System

(71) Applicant: Jomo Fuller, South San Francisco, CA (US)

(72) Inventor: Jomo Fuller, South San Francisco, CA (US)

(21) Appl. No.: 15/863,943

(22) Filed: Jan. 7, 2018

Related U.S. Application Data
(60) Provisional application No. 62/444,254, filed on Jan. 9, 2017.

(51) Int. Cl. A01G 9/16; A01G 9/26; A01G 9/24; A01G 9/22; A01G 9/14

(52) U.S. Cl. CPC A01G 9/16; A01G 9/26; A01G 9/1469; A01G 9/227; A01G 9/246

(57) ABSTRACT

The present invention is generally related to a system for growing plants in a controlled environment, and more particularly related to a system for growing plants in a mobile and controlled environment wherein the system may be built from re-purposed or recycled materials such as one or more shipping containers or box trailers. The herein disclosed system for growing plants in a mobile and controlled environment may be utilized in locations which are not normally suitable for growing and harvesting crops, thus benefiting the local populations of historically unproductive areas.

### CROSS-REFERENCES TO RELATED APPLICATIONS

This non-provisional utility application takes priority to the previously filed provisional application: Application No. 62/444,254 filed Jan. 9, 2017, which is hereby incorporated in its entirety by reference

### BRIEF DESCRIPTION OF THE INVENTION

The present invention is generally related to a system for growing plants in a controlled environment, and more particularly related to a system for growing plants in a mobile and controlled environment wherein the system may be built from repurposed or recycled materials such as one or more shipping containers or box trailers. The herein disclosed system for growing plants in a mobile and controlled environment may be utilized in locations which are not normally suitable for growing and harvesting crops, thus benefiting the local populations of historically unproductive areas. The present invention further includes methods for building a system for growing plants in a mobile and controlled environment from readily available repurposable material such as a standard box trailer or a standard shipping container.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

The present invention is generally related to a system for growing plants in a controlled environment, and more particularly related to a system for growing plants in a mobile and controlled environment wherein the system may be built from repurposed or recycled materials such as one or more shipping containers or box trailers.

Most plants, vegetables, and other vegetative crops are grown in one of two primary ways. In exterior conditions such as a standard field or a covered, but not fully controlled, environment such as a greenhouse. Or in interior conditions such as man-made and fully controlled environments. Both systems have their advantages when properly applied, however, they both also have disadvantages inherent to them that can greatly influence the end product in either quality of product or overall production rates.

The herein disclosed system for growing plants in a mobile and controlled environment was created to (1) utilize the strengths of both interior and exterior growing conditions, while providing an environment that allows the grower to control the conditions that ensure the best product in both quality and yield, (2) allow the growth and harvesting of plants and vegetables in locations and areas that are not naturally suited for their production due to the systems controlled environment, mobility, and solar powered design, and (3) be environmentally friendly by utilizing recycled materials, as well as repurposing other existing items in conjunction with its solar powered design.

### BRIEF DESCRIPTION OF THE SEVERAL VIEWS OF THE DRAWING

FIG. 1A illustrates an overhead view of an exemplary embodiment of the herein disclosed system for growing plants in a mobile and controlled environment, in accordance with the present invention;

FIG. 1B illustrates a side view of an exemplary embodiment of the herein disclosed for growing plants in a mobile and controlled environment, in accordance with the present invention;

FIG. 2 illustrates an overhead view of the interior of an exemplary embodiment of the herein disclosed system for growing plants in a mobile and controlled environment, in accordance with the present invention;

FIG. 3A illustrates a cutaway view of a cross section of an exemplary embodiment of the herein disclosed system for growing plants in a mobile and controlled environment, showing an exemplary embodiment of components attaching the solar ceiling to the growth system base, in accordance with the present invention;

FIG. 3B illustrates a cutaway view of a cross section of an exemplary embodiment of the herein disclosed system for growing plants in a mobile and controlled environment, showing an exemplary embodiment of components forming one or more interior walls of the system, in accordance with the present invention; and

FIG. 4 illustrates a flow diagram for an exemplary embodiment of the herein disclosed method for manufacturing a system for growing plants in a mobile and controlled environment, in accordance with the present invention.

### DETAILED DESCRIPTION OF THE INVENTION

The present invention is generally related to a system for growing plants in a controlled environment, and more particularly related to a system for growing plants in a mobile and controlled environment wherein the system may be built from repurposed or recycled materials such as one or more shipping containers or box trailers. The herein disclosed solar-powered system for growing plants in a mobile and controlled environment may be utilized in locations not normally suitable for growing and harvesting crops, thus benefiting the local populations of historically unproductive areas.

The present invention further includes methods for building a system for growing plants in a mobile and controlled environment from readily available repurposable material such as a standard box trailer or a standard shipping container. The herein disclosed system for growing plants in a mobile and controlled environment may be built from a growth system base that may be a box trailer or a shipping container. For example, a standard 53-foot box trailer, which is normally used for transportation of goods via a trailer truck, may be used as the growth system base. A standard 20-foot or 40-foot shipping container may alternatively be used as the growth system base. And those skilled in the art will also recognize that other sizes of box trailers or shipping containers may alternatively be used as the growth system base for building the herein disclosed system for growing plants in a mobile and controlled environment.

In an exemplary embodiment, the herein disclosed method for building a system for growing plants in a mobile and controlled environment starts with removal of a top portion of the growth system base. A next step includes building, or adding, interior structural framework to the growth system base interior. For example, one or more interior dividing walls may be installed, which may subdivide an interior of the growth system base into a grow room section, a control room section, and a foyer section. Alternative interior configurations will be readily apparent to those skilled in the art, and all such alternative interior configurations are intended to be included herein. The interior walls may be insulated, and the walls of the growth system base may also be insulated. The growth system base walls may be insulated by the addition of plywood wallboards, for example.

A next step of the herein disclosed method includes building a solar ceiling above a portion of the growth system base. For example, the solar ceiling may be built overhead of the grow room section of the growth system base. The solar ceiling may be formed of one or more translucent acrylic panels and structural supports and connections for the one or more translucent acrylic panels. Those skilled in the art will recognize that many alternatives are available for providing a ceiling that allows natural light to enter the growth system base (and the grow room section, for example) in a partially for fully controlled manner, and all such alternatives are intended to be included herein. The solar ceiling may be sealed to prevent air and/or water infiltration into the growth system base or the grow room section of the growth system base. Another step of the herein disclosed method may include treating one or more of the interior growth system base walls (or just the grow room section) to prevent microbial infestations, as is known in the art. Another step of the herein disclosed method may include painting one or more interior growth system base walls (or just the grow room section) with high gloss and/or high reflective paint. Growing platforms, such as tables or other known raised-bed type grow containers, may be installed within the growth system base (or the grow room section).

Another step of the herein disclosed method for building a system for growing plants in a mobile and controlled environment may include the addition of a power system to the growth system base. A power system may be installed within the control room of the growth system base, and may include one or more solar panels, one or more solar batteries, one or more solar charge controllers, one or more DC power inverters, and wiring necessary to operably connect the several power system components.

In an exemplary embodiment, another step may include adding a blackout system for controlling a received light amount (controlling the amount of light received by one or more plants growing within the growth system base or the grow room) and/or for controlling a light time (controlling a length of time in which the growing environment is actively lit). The blackout system may be referred to as a light deprivations system or a light deprivation module. In a preferred embodiment, the light deprivation module may be a mechanical pulley-arm that controllably rolls a tarp along at least a portion of the length of the solar ceiling. Certain embodiments may position the light deprivation module in proximity to the outside of the solar ceiling, so that the tarp is mechanically rolled into position outside a weather-sealed grow room.

Another step of the herein disclosed system for growing plants in a mobile and controlled environment includes adding one or more environmental controls to the growth system base. The one or more environmental controls may be positioned within, or partially within, the grow room of the growth system base, and may be operably connected to control displays or control devices positioned within, or partially within, the control room section of the of the growth system base. The one or more environmental controls may include one or more air conditioning units, one or more fans, one or more supplemental lighting systems, and one or more automated feeding (or fertilizing) systems.

The herein disclosed method for building a system for growing plants in a mobile and controlled environment may also include a step for testing the operation of the solar ceiling, the blackout system, the power system, and/or the environmental controls to ensure that the one or more systems within the overall solar-powered system for growing playing in a mobile and controlled environment are working as desired.

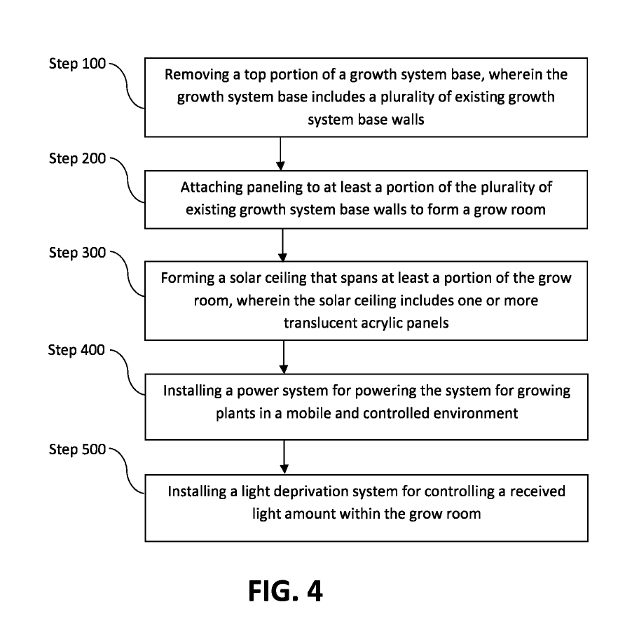

Referring to FIG. 4, an exemplary embodiment of the herein disclosed method for manufacturing a system for growing plants in a mobile and controlled environment is illustrated. The herein disclosed methods include step 100 removing a top portion of a growth system base, wherein the growth system base includes a plurality of existing growth system base walls. As described herein, a growth system base may be any transportable structure capable of housing the system for growing plants in a mobile and controlled environment. For example, the growth system base may be a standard 53-foot box trailer. Alternatively, the growth system base may be a shipping container of any size (standard sizes for shipping containers are normally 20 feet in length or 40 feet in length), or any other type of transportable structure known in the art.

The method for manufacturing the herein disclosed system may then include step 200 attaching paneling to at least a portion of the plurality of existing growth system base walls to form a grow room within the growth system base. In certain embodiments, step 200 may include insulating a space between the paneling and the existing growth system base walls and/or covering a surface of the paneling with a highly reflective finish (such as high-gloss paint, for example) so as to advantageously reflect natural light received through the solar ceiling. Step 200 may also include forming one or more interior walls for subdividing the growth system base to form additional rooms in addition to the grow room, such as a control room.

The herein disclosed methods further include step 300 forming a solar ceiling that spans at least a portion of the grow room, wherein the solar ceiling includes one or more translucent acrylic panels. Those skilled in the art will recognize that alternative materials or components may be used to form a solar ceiling that can selectively (or controllably) allow natural light to enter the grow room, and all such alternative materials or components are intended to be included herein.

The herein disclosed methods further include step 400 installing a power system for powering the system for growing plants in a mobile and controlled environment. And the herein disclosed methods further include step 500 installing a light deprivation system for controlling a received light amount within the grow room. In certain embodiments that include forming a control room in addition to forming a grow room, the method may further include a step of communicatively coupling the power system and the light deprivation system to a control system positioned within the control room.

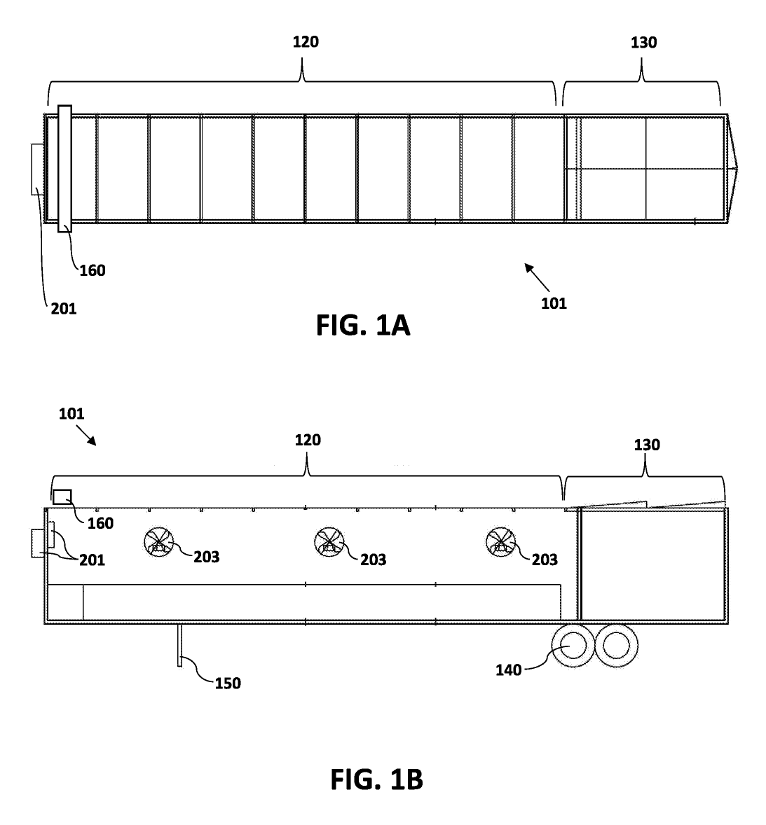

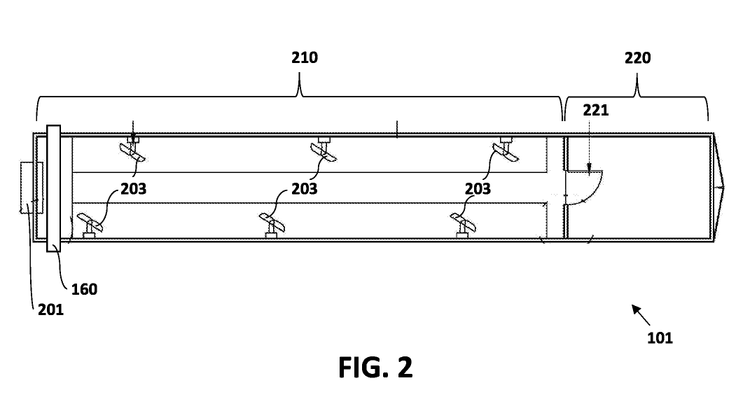

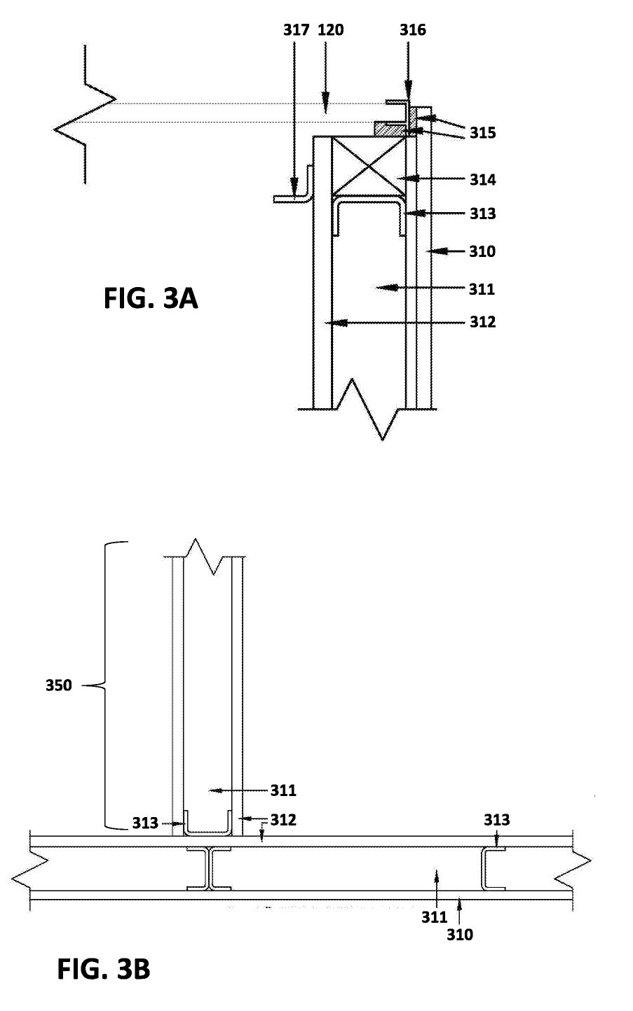

The present invention includes a system for growing plants in a mobile and controlled environment. The herein disclosed system and various embodiments are illustrated in FIG. 1A, FIG. 1B, FIG. 2, FIG. 3A, and FIG. 3B and will now be described. Referring to FIG. 1A, an exemplary embodiment of the herein disclosed system is shown from an overhead view. System for growing plants in a mobile and controlled environment 101 (also referred to throughout as “system 101”) may be formed, via the herein disclosed method for building the solar-powered system for growing plants in a mobile and controlled environment, from a standard box trailer or a standard shipping container. As can be seen in FIG. 1A, a top side of system 101 may include solar ceiling 120 and solar power panels 130. An alternative embodiment may utilize a solar ceiling spanning the entire ceiling of system 101; such an alternative embodiment may not utilize solar power panels 130. Solar ceiling 120 may be formed of one or more translucent acrylic panels and structural supports and connections for the one or more translucent acrylic panels. Those skilled in the art will recognize that many alternatives are available for providing a ceiling that allows natural light to enter the growth system base (and the grow room section, for example) in a partially, or fully, controlled manor, and all such alternatives are intended to be included herein. Solar ceiling 120 may be sealed to prevent air and/or water infiltration into the growth system base or the grow room section of the growth system base. Optional solar power panels 130 are used for collecting exterior sunlight and converting the exterior sunlight to energy which may be stored in one or more solar batteries and controlled by one or more solar charge controllers, as is known in the art.

Referring to FIG. 1B, an exemplary embodiment of the herein disclosed system is shown from a side view. Solar ceiling 120 may span a portion of the top of system 101, with solar power panels 130 utilizing a remaining portion of the top of system 101. As can be seen in FIG. 1B, if a box trailer is utilized to form or build system 101, system 101 may include one or more sets of wheels plus axels 140 and one or more trailer stand 150.

Referring to FIG. 2, an exemplary embodiment an interior of the herein disclosed system 101 for growing plants in a mobile and controlled environment is shown from an overhead view (system 101 top, including solar ceiling 120 and solar power panels 130 are omitted from FIG. 2 so that the interior regions of system 101 are visible). System 101 may be subdivided into a plurality of sections. For example, and as illustrated in FIG. 2, system 101 may be divided into a grow room 210 and a control room 220. Alternative embodiments of the present invention may subdivide system 101 into additional sections; for example, control room 220 may be further divided so that an additional section, such as a foyer section or foyer room, is created within system 101. Alternatively, the entire interior of system 101 may be one contiguous space and the one contiguous space may include all, or some of, the components described herein.

Grow room 210 may include one or more air conditioning units 201, which may be a split-system air conditioning units as are known in the art. Grow room 210 may also include one or more air circulation fans 203 (which may be operably connected to a control device in system 101 or in control room 220 of system 101), and one or more air enrichment systems (which may be operably connected to a control device in system 101 or in control room 220 of system 101), and one or more growth platforms, which may be tables or other known raised-bed type grow containers as are known in the art. Grow room 210 may also include one or more blackout systems for controlling a received light amount (controlling the amount of light received by one or more plants growing within the growth system base or the grow room) and/or for controlling a light time (controlling a length of time in which the growing environment is actively lit). The blackout system may be referred to as a light deprivation system. In an exemplary embodiment of the present invention, and as illustrated in the various figures, the light deprivation system may include mechanical light deprivation module 160 for mechanically controlling the amount of light received by the one or more plants growing within system 101. In a preferred embodiment, mechanical light deprivation module 160 is a mechanical pulley-arm that can controllably roll a tarp along the length of solar ceiling 120. Mechanical light deprivation module 160 may be communicatively coupled to a control system of system 101, so that the mechanical light deprivation module 160 may be controlled from within control room 130.

Control room 220 may include one or more water storage tanks, which may be operably connected to a watering system for watering plants in grow room 210, one or more storage racks, and one or more solar batteries (which may be referred to as solar battery banks). Control room 220 may, in certain embodiments, act as an air lock to facilitate control over the environment of grow room 210, including air pressure in grow room 210, by providing a controlled sub-environment in between grow room 210 and the exterior environment surrounding system 101.

The one or more interior walls of system 101 may form one or more interior doors 221. In a preferred embodiment of the present invention, interior door 221 may be sealed so as to maintain separate environments in grow room 210 and control room 220.

Those skilled in the art will recognize that the herein disclosed system for growing plants in a mobile and controlled environment may be made, formed, or manufactured in a variety of dimensions while continuing to provide the desired characteristics of mobility and environmental controls for the growth environment, and all such dimensions are intended to be included herein. A preferred embodiment of the herein disclosed system may utilize a plant growth base (a trailer or container, for example) that is approximately 53 feet in length and approximately 8 feet in width. In this preferred embodiment, grow room 210 may utilize approximately 41 feet of the length of system 101 and control room 220 may utilize the remaining approximately 12 feet of the length of system 101. A preferred embodiment may also utilize translucent acrylic panels of approximately 4 feet in length.

Referring to FIG. 3A, an exemplary embodiment of a cross section of system 101 is shown to demonstrate preferred components for supporting solar ceiling 120. Existing trailer wall 310 (or existing container or base wall 310) can be paneled by paneling 312 (plywood, for example). Paneling 312 may be supported by one or more studs 313, with the space between paneling 312 and existing trailer wall 310 filled or partially filled by insulation 311. Support section 314 may be formed of a 2-inch wood beam, cut to size. Bracket 316 (which may be an F-section type bracket) holds solar ceiling 120 in place in proximity to existing trailer wall 310, with weather stripping 315 providing a weather-tight seal between solar ceiling 120 and existing trailer wall 310. Those skilled in the art will recognize that additional connection types, utilizing differing connecting components, may be utilized to support solar ceiling 120 and all such connection types are intended to be included herein.

Referring to FIG. 3B, an exemplary embodiment of a cross section of system 101 is shown to demonstrate preferred components for supporting one or more interior walls of system 101. Interior wall 350 includes paneling 312 (which may be ⅝^{th} inch plywood, for example) supported by stud 313. The space between paneling 312 may be filled, or partially filled, by insulation 311. Interior wall 350 may attach to paneling 313, which is supported by stud 313 in proximity to existing trailer wall 310. The space between existing trailer wall 310 and paneling 312 may also be filled, or partially filled, by insulation 311. As is apparent in FIG. 3B, interior wall 350 may attach directly to paneling 313, as opposed to attaching directly to existing trailer wall 310. Those skilled in the art will recognize that additional connection types, utilizing differing connecting components, may be utilized to support interior wall 350 and all such connection types are intended to be included herein.

While the present invention has been illustrated and described herein in terms of a preferred embodiment and several alternatives, it is to be understood that the system and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. A system for growing plants, comprising:
a grow room covered at least partially by a solar ceiling, wherein the solar ceiling is for selectively allowing natural light to be received by the plants and wherein the solar ceiling includes a plurality of translucent acrylic panels;
one or more air circulation fans for circulating air within the grow room;
one or more air conditioning units for controlling a temperature of the grow room; and
a light deprivation module for controlling an amount of light entering the grow room.

2. The system for growing plants as recited in claim 1, wherein the light deprivation module operates mechanically to control the amount of light entering the grow room.

3. The system for growing plants as recited in claim 2, wherein the light deprivation module includes a mechanically pulley-arm for controllably rolling a tarp along a length of the solar ceiling.

4. The system for growing plants as recited in claim 1, further comprising a control room and wherein the one or more air circulation fans, the one or more air conditioning units, and the light deprivation module are communicatively coupled to a control system located in the control room.

5. The system for growing plants as recited in claim 4, wherein the grow room and the control room are formed within a standard 53-foot box trailer.

6. The system for growing plants as recited in claim 4, wherein the grow room and the control room are formed within a shipping container.

7. The system for growing plants as recited in claim 1, wherein the grow room is formed within a 53-foot box trailer.

8. The system for growing plants as recited in claim 1, wherein the grow room is formed within a shipping container.

9. The system for growing plants as recited in claim 7, further comprising:
paneling on one or more walls of the grow room, wherein the paneling is supported by one or more studs attached to an interior wall of the 53-foot box trailer.

10. The system for growing plants as recited in claim 9, wherein a space between the paneling and the interior wall of the 53-foot box trailer is at least partially filled by insulation.

11. The system for growing plants as recited in claim 9, wherein one or more brackets support the plurality of translucent acrylic panels, and wherein space between the one or more brackets and the interior wall of the 53-foot box trailer is at least partially filled by weather stripping.

12. The system for growing plants as recited in claim 9, further comprising a control room formed by one or more interior walls, and wherein the one or more interior walls are supported by the paneling.

13. A method for manufacturing a system for growing plants in a mobile and controlled environment, comprising the steps of:
removing a top portion of a growth system base, wherein the growth system base includes a plurality of existing growth system base walls;
attaching paneling to at least a portion of the plurality of existing growth system base walls to form a grow room within the growth system base;
forming a solar ceiling that spans at least a portion of the grow room, wherein the solar ceiling includes one or more translucent acrylic panels;
installing a power system for powering the system for growing plants in a mobile and controlled environment; and
installing a light deprivation system for controlling a received light amount within the grow room.

14. The method for manufacturing a system for growing plants in a mobile and controlled environment as recited in claim 13, wherein the growth system base is a standard 53-foot box trailer.

15. The method for manufacturing a system for growing plants in a mobile and controlled environment as recited in claim 13, wherein the step of attaching paneling includes insulating a space between the paneling and the existing growth system base walls.

16. The method for manufacturing a system for growing plants in a mobile and controlled environment as recited in claim 13, wherein the step of attaching paneling includes covering at least a portion of a surface of the paneling with a highly reflective paint for reflecting natural light received through the solar ceiling.

17. The method for manufacturing a system for growing plants in a mobile and controlled environment as recited in claim 13, wherein the step of attaching paneling includes forming one or more interior walls for subdividing the growth system base to form a control room.

18. The method for manufacturing a system for growing plants in a mobile and controlled environment as recited in claim 17, further comprising the step of communicatively coupling the power system and the light deprivation system to a control system positioned within the control room.
